(19) United States
(12) Patent Application Publication
(10) Pub. No.: US 2022/0080872 A1
(43) Pub. Date: Mar. 17, 2022

(54) CUP HOLDER UNIT

(71) Applicants: TOYOTA JIDOSHA KABUSHIKI KAISHA, Toyota-shi (JP); SUBARU CORPORATION, Tokyo (JP)

(72) Inventor: Keiichi Saito, Kasugai-shi (JP)

(73) Assignees: TOYOTA JIDOSHA KABUSHIKI KAISHA, Toyota-shi Aichi-ken (JP); SUBARU CORPORATION, Tokyo (JP)

(21) Appl. No.: 17/460,855

(22) Filed: Aug. 30, 2021

(30) Foreign Application Priority Data
Sep. 15, 2020 (JP) 2020-154840

(51) Int. Cl. B60N 3/10; B60R 11/02

(52) U.S. Cl. CPC B60N 3/107; B60R 2011/0003; B60R 11/0241; B60N 3/101

(57) ABSTRACT

A cup holder unit includes: a cup holder; and a slit groove provided adjacent to the cup holder and arranged to accommodate a cellular phone. The slit groove has a bottom face, a first side face situated on a side farther from the cup holder than the bottom face, and a second side face situated on a side closer to the cup holder than the bottom face. The bottom face has a first inclined face inclined so as to be displaced further downward the farther away from the first side face, in a range adjacent to the first side face. A center of a bottommost portion of the bottom face is situated at a position closer to the second side face than the first side face, in a cross-section traversing the slit groove.

### CROSS-REFERENCE TO RELATED APPLICATION

This application claims priority to Japanese Patent Application No. 2020-154840 filed on Sep. 15, 2020, incorporated herein by reference in its entirety.

### BACKGROUND

### 1. Technical Field

The present disclosure relates to a cup holder unit.

### 2. Description of Related Art

Japanese Unexamined Patent Application Publication No. 2002-187473 (JP 2002-187473 A) discloses a cup holder for a vehicle. A beverage container can be placed in the cup holder.

### SUMMARY

A slit groove, for holding a cellular phone, can be provided adjacent to the cup holder. When the cellular phone is held in such a slit groove in a state tilted toward the cup holder side, the cellular phone is readily smudged by the beverage container held in the cup holder. The present disclosure proposes technology that can suppress smudging of the cellular phone in the slit groove (slit groove for holding cellular phone) provided adjacent to the cup holder.

A cup holder unit according to an aspect of the present disclosure includes: a cup holder; and a slit groove that is provided adjacent to the cup holder and that is arranged to accommodate a cellular phone, with an extended line of a center axis extending in a direction that does not intersect the cup holder in top view. The slit groove has a bottom face, a first side face situated on a side farther from the cup holder than the bottom face, and a second side face situated on a side closer to the cup holder than the bottom face. The bottom face has a first inclined face that is inclined so as to be displaced further downward the farther away from the first side face, in a range adjacent to the first side face. A center of a bottommost portion of the bottom face is situated at a position closer to the second side face than the first side face, in a cross-section traversing the slit groove.

According to the above aspect, in this cup holder unit, when the cellular phone is inserted into the slit groove, the bottom portion of the cellular phone tends to strike against the first inclined face of the bottom face of the slit groove. When the bottom portion of the cellular phone strikes against the first inclined face, the bottom portion of the cellular phone slides toward the center of the bottommost portion of the bottom face of the slit groove (i.e., toward the side closer to the cup holder). The cellular phone then is inclined with the upper portion of the cellular phone away from the cup holder, and the cellular phone is held in the slit groove in such an inclined state. Accordingly, a broad spacing is secured between the cellular phone held in the slit groove and the beverage container held in the cup holder. Thus, smudging of the cellular phone is suppressed.

In the above aspect, the bottom face may have a second inclined face that is inclined so as to be displaced further downward the farther away from the second side face, in a range adjacent to the second side face. A width of the first inclined face in a lateral direction may be greater than a width of the second inclined face in the lateral direction, in the cross-section traversing the slit groove.

In the above aspect, the bottom face may have a flat face that extends generally laterally, and that is situated at the bottommost portion of the bottom face. A center of the flat face may be situated at a position closer to the second side face than the first side face.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a sectional view of a cup holder unit 10 (sectional view taken along line I-I in FIG. 2);

FIG. 2 is a top view of the cup holder unit 10;

FIG. 3 is an enlarged cross-sectional view of a slit groove 30;

FIG. 4 is an enlarged cross-sectional view of the slit groove 30 according to a first modification;

FIG. 5 is an enlarged cross-sectional view of the slit groove 30 according to a second modification; and

FIG. 6 is an enlarged cross-sectional view of the slit groove 30 according to a third modification.

### DETAILED DESCRIPTION OF EMBODIMENTS

In a cup holder unit according to an example disclosed in the present specification, the bottom face may have a second inclined face that is inclined so as to be displaced further downward the farther away from the second side face, in a range adjacent to the second side face. Also, a width of the first inclined face in a lateral direction may be greater than a width of the second inclined face in the lateral direction, in a cross-section traversing the slit groove.

According to this configuration, when inserting the cellular phone into the slit groove, a bottom portion of the cellular phone tends to strike against the first inclined face than the second inclined face. Accordingly, the cellular phone is readily held in the slit groove in a state in which the upper portion of the cellular phone is inclined in a direction away from the cup holder.

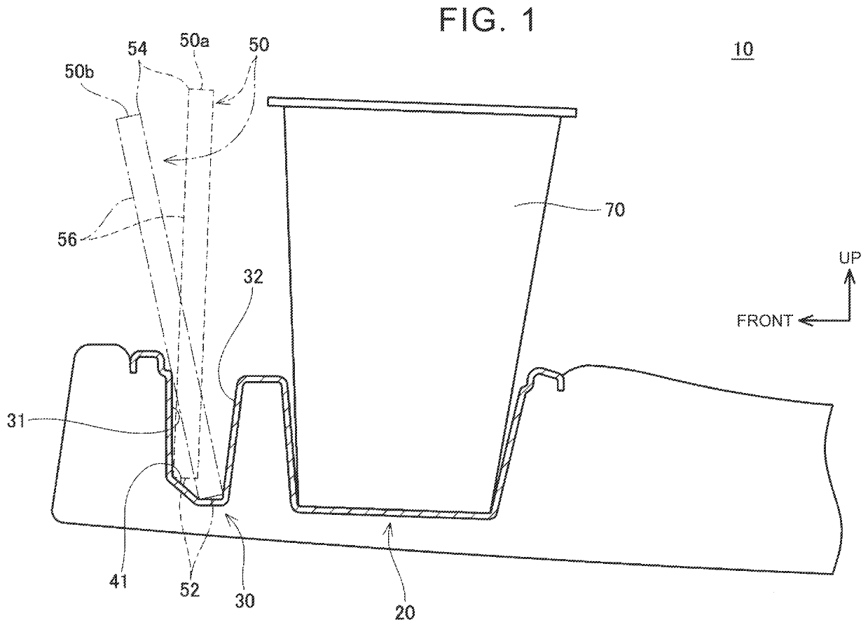

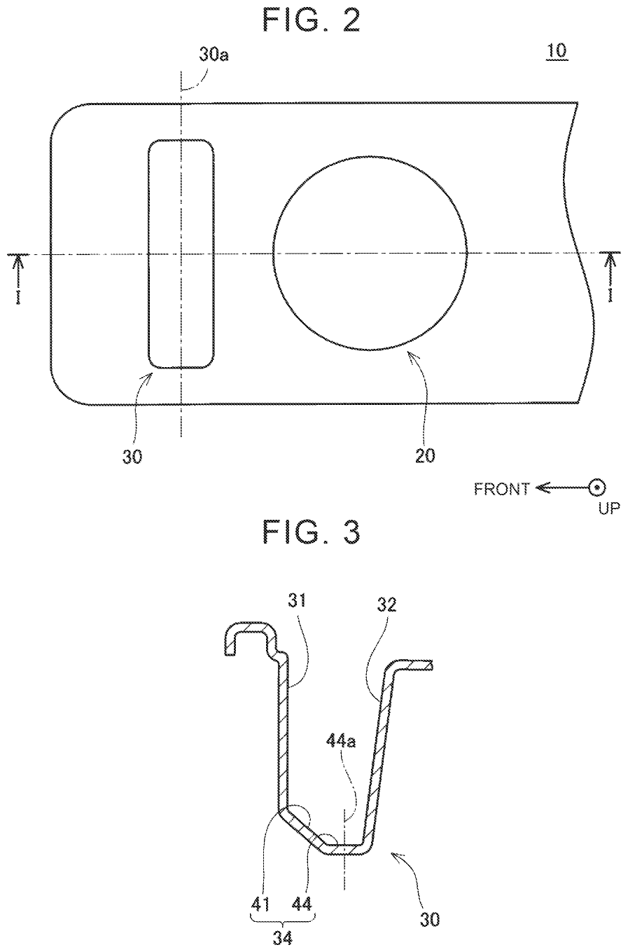

The cup holder unit 10 illustrated in FIGS. 1 and 2 is used as an armrest of a seat of an automobile. The cup holder unit 10 has a cup holder 20 and a slit groove 30.

The cup holder 20 is a substantially circular hole provided in an upper face of the cup holder unit 10. The cup holder 20 stably holds a beverage container 70 inserted into the cup holder 20.

The slit groove 30 is a groove provided in the upper face of the cup holder unit 10. The slit groove 30 is provided forward (in the direction of advance of the vehicle) of the cup holder 20. The slit groove 30 is provided adjacent to the cup holder 20. The slit groove 30 is elongated in the vehicle width direction (right-left direction of vehicle) in top view, as illustrated in FIG. 2. Accordingly, the slit groove 30 extends in a direction such that an extended line 30a of the center axis of the slit groove 30 does not intersect with the cup holder 20, in top view.

The slit groove 30 has a bottom face 34, a first side face 31, and a second side face 32, as illustrated in FIG. 3. The first side face 31 is situated forward from the bottom face 34. That is to say, the first side face 31 is situated on a side farther from the cup holder 20 than the bottom face 34. The second side face 32 is situated rearward from the bottom face 34. That is to say, the second side face 32 is situated on a side closer to the cup holder 20 than the bottom face 34.

The bottom face 34 connects a lower end of the first side face 31 and a lower end of the second side face 32. The bottom face 34 has a flat face 44 and an inclined face 41. The flat face 44 extends upon a plane substantially orthogonal to the up-down-direction of the vehicle (also referred to as “lateral” herein). The inclined face 41 is situated between the flat face 44 and the first side face 31. The inclined face 41 is disposed within a range adjacent to the first side face 31. The inclined face 41 is inclined so as to be displaced further downward the farther away from the first side face 31. The inclined face 41 connects the first side face 31 and the flat face 44. The flat face 44 is connected to the second side face 32.

The flat face 44 extends in the lateral direction, as described above. Accordingly, the entire flat face 44 is the bottommost portion of the bottom face 34. In a cross-section that traverses the slit groove 30, a center 44a of the flat face 44 (i.e., the center of the bottommost portion of the bottom face 34) is situated at a position closer to the second side face 32 than to the first side face 31, as illustrated in FIG. 3.

When a cellular phone 50 is inserted into the slit groove 30, a bottom portion 52 of the cellular phone 50 strikes the inclined face 41, as illustrated by dashed lines 50a in FIG. 1. The bottom portion 52 then slides following the inclined face 41 to the side closer to the second side face 32, as indicated by long dashed short dashed lines 50b in FIG. 1. The cellular phone 50 is then inclined with an upper portion 54 of the cellular phone 50 away from the second side face 32. Thus, a side face 56 (side face toward the first side face 31) of the cellular phone 50 is in contact with an upper end of the first side face 31, and the cellular phone 50 is stably held. In this way, when the cellular phone 50 is inserted into the slit groove 30, the cellular phone 50 is held in a state in which the cellular phone 50 is inclined to the first side face 31 side.

There are cases in which the cellular phone 50 is smudged due to the cellular phone 50 coming into contact with the beverage container 70 when the cellular phone 50 inserted into the slit groove 30 is inclined to the cup holder 20 side. Conversely, in the cup holder unit 10 according to the present embodiment, the cellular phone 50 is held in the slit groove 30 in a state inclined to the first side face 31 side, as described above. Accordingly, a broad spacing is secured between the cellular phone 50 accommodated in the slit groove 30 and the beverage container 70 accommodated in the cup holder 20. More particularly, a broad spacing is secured between upper portion 54 of the cellular phone 50 and the upper portion of the beverage container 70. Thus, smudging of the cellular phone 50 is suppressed.

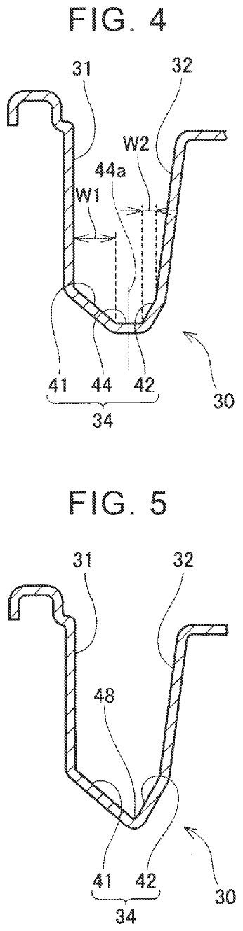

Note that the bottom face 34 of the slit groove 30 has the inclined face 41 and the flat face 44 in the above-described embodiment. However, the bottom face 34 may further have an inclined face 42, as illustrated in FIG. 4. The inclined face 42 is situated between the flat face 44 and the second side face 32. The inclined face 42 is provided in a range adjacent to the second side face 32. The inclined face 42 is inclined so as to be displaced further downward the farther away from the second side face 32. The inclined face 42 connects the second side face 32 and the flat face 44. In a cross-section that traverses the slit groove 30, a width W1 in the lateral direction of the inclined face 41 is greater than a width W2 of the inclined face 42 in the lateral direction, as illustrated in FIG. 4. In this configuration, the width W1 of the inclined face 41 is greater than the width W2 of the inclined face 42, and accordingly, when the cellular phone 50 is inserted into the slit groove 30, the bottom portion 52 of the cellular phone 50 strikes the inclined face 41 more readily. Accordingly, the cellular phone 50 is held in the slit groove 30 in a state inclined to the first side face 31 side, in the same way as in the above-described embodiment. Thus, smudging of the cellular phone 50 can be suppressed.

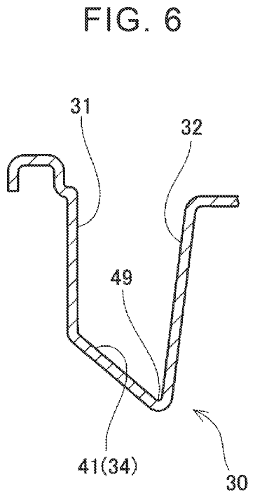

Also, an arrangement may be made in which the bottom face 34 has the inclined faces 41 and 42 but does not have the flat face 44, as illustrated in FIG. 5. In the configuration in FIG. 5, the inclined face 41 is directly connected to the inclined face 42. In this case, the bottommost portion of the bottom face 34 is a connecting portion 48 of the inclined face 41 and the inclined face 42, and the center of the bottommost portion of the bottom face 34 is the connecting portion 48 itself. Also, an arrangement may be made in which the bottom face 34 has neither the inclined face 42 nor the flat face 44, as illustrated in FIG. 6, and the inclined face 41 is directly connected to the second side face 32. In this case, the bottommost portion of the bottom face 34 is a connecting portion 49 of the inclined face 41 and the second side face 32, and the center of the bottommost portion of the bottom face 34 is the connecting portion 49 itself. As exemplified in FIGS. 5 and 6, in an arrangement in which the bottom face 34 has the inclined face 41 in a range adjacent to the first side face 31, and the center of the bottommost portion of the bottom face 34 is situated at a position closer to the second side face 32 than the first side face 31, the slit groove 30 can hold the cellular phone 50 in a state inclined to the first side face 31 side, and smudging of the cellular phone 50 can be suppressed.

Although an embodiment has been described in detail, these are only exemplifications, and do not limit CLAIMS. The technology set forth in CLAIMS includes various modifications and alterations of the specific example exemplified above. Technical elements described in the present specification or the drawings exhibit technical utility, either singularly or through various types of combinations, and do not limit combinations set forth in CLAIMS at the time of application. Also, the technology exemplified in the present specification or the drawings may achieve a plurality of objects simultaneously, and achieving one of these objects in itself has technical utility.

What is claimed is:

1. A cup holder unit, comprising:
a cup holder; and
a slit groove that is provided adjacent to the cup holder, and that is arranged to accommodate a cellular phone, with an extended line of a center axis extending in a direction that does not intersect the cup holder in top view, wherein:
the slit groove has a bottom face, a first side face situated on a side farther from the cup holder than the bottom face, and a second side face situated on a side closer to the cup holder than the bottom face;
the bottom face has a first inclined face that is inclined so as to be displaced further downward the farther away from the first side face, in a range adjacent to the first side face; and
a center of a bottommost portion of the bottom face is situated at a position closer to the second side face than the first side face, in a cross-section traversing the slit groove.

2. The cup holder unit according to claim 1, wherein:
the bottom face has a second inclined face that is inclined so as to be displaced further downward the farther away from the second side face, in a range adjacent to the second side face; and
a width of the first inclined face in a lateral direction is greater than a width of the second inclined face in the lateral direction, in the cross-section traversing the slit groove.

3. The cup holder unit according to claim 1, wherein:
the bottom face has a flat face that extends generally laterally, and that is situated at the bottommost portion of the bottom face; and
a center of the flat face is situated at a position closer to the second side face than the first side face.
